(19) United States
(12) Patent Application Publication
(10) Pub. No.: US 2008/0210049 A1
(43) Pub. Date: Sep. 4, 2008

(54) Damping Device, Particularly for a Dual Mass Flywheel

(76) Inventor: Ulrich Rohs, Duren (DE)

Correspondence Address: COLLARD & ROE, P.C., 1077 NORTHERN BOULEVARD, ROSLYN, NY, 11576, US

(21) Appl. No.: 11/795,978

(22) PCT Filed: Dec. 30, 2005
(86) PCT No.: PCT/DE05/02333

§ 371 Date: Aug. 9, 2007

(30) Foreign Application Priority Data
Jan. 26, 2005 (DE) 102005003798.4
Mar. 17, 2005 (DE) 102005012861.0

(51) Int. Cl. F16F 15/139

(52) U.S. Cl. 74/574.3

(57) ABSTRACT

A damping device (1), particularly for a dual mass flywheel, comprising a first component (2) and a second component and a friction device (4) arranged therebetween, characterized in that the second component has two distanced surfaces (5,6) and the first component is arranged between the surfaces, also comprising a third component (8) which is also arranged between the surfaces. When the third component and first component move towards each other, they are braced in such a way that surfaces of the first and third component are pressed against surfaces of the second component.

The invention relates to a damping device, particularly for a dual mass flywheel, comprising a first component and a second component and a friction device arranged therebetween.

The most varied types of damping devices have been proposed for vibration dampers, and particularly for dual mass flywheels. Whereas the spring system of a dual mass flywheel generally operates with very low damping values, generally a separate damping system serves to achieve specific damping values in accordance with precise dynamic parameters. Lubricated damping devices are known here, which have grease which acts in the region of the friction surfaces. Other damping devices operate dry, in order to extract energy from the system by friction under particular load conditions.

The invention is based on the problem of proposing a new damping system which is able to be integrated easily into known duel mass flywheels and which fulfils the required damping characteristics in an optimum manner.

This problem is solved by a generic damping device in which the second component has two distanced surfaces and the first component is arranged between said surfaces, also comprising a third component which is also arranged between said surfaces, in which, when the third component and first component move towards each other, they are braced in such a way that surfaces of the first and third component are pressed against surfaces of the second component.

The damping device according to the invention therefore provides various components which are braced on a relative movement towards each other, so that components are pressed against each other and produce friction. The damping device is to be composed of few components and it can thereby be integrated at various areas into a dual mass flywheel.

One variant embodiment makes provision that the first component is able to be connected with a drive and the second component with an output. As an alternative to this, however, the first component may also be able to be connected with an output and the second component with a drive.

It is particularly advantageous if a ring-shaped space is formed between the distanced surfaces. This is preferably achieved by a ring-shaped formation of the components delimiting the space. At least a portion of the third component is then situated inside the ring-shaped space, and the friction surfaces are preferably arranged inside this ring-shaped space.

The ring-shaped space can only be indicated by the first and second component. It may, however, also be substantially closed radially towards the exterior. It thereby forms a chamber which also makes it possible, for example, to allow the abrading of some individual items of the components hitherto described on the surface of this space lying radially on the outside.

However, the ring-shaped space forms the great advantage that it is suited to receiving lubricant. It can therefore hold grease arranged in the friction device, or a liquid lubricant, and can thereby provide for an optimum wetting of the friction surfaces which are to be lubricated.

Particularly when lubricant can penetrate from radially inwards into the ring-shaped space, it is advantageous if this lubricant can also leave this space again. To do this, it is proposed that the ring-shaped space has openings for the inflow and outflow of lubricant. In one example embodiment, the surface of the ring-shaped space lying radially on the inside is opened fully up to the component which projects into the space, whereas the surface of the ring-shaped space lying radially on the outside has bores through which the lubricant can arrive radially outwards.

An advantageous variant embodiment makes provision that the first and the third component are movable relative to each other between the surfaces of the second component, and are arranged movably with respect to a second component. The surfaces of the second component therefore form a boundary between which the first and the third components are arranged. These surfaces of the second component are parallel, flat surfaces for example, which form between them an approximately rectangular space to receive the first and the third components. The rectangular cross-section of this space must not, however, have the same dimensions over the entire peripheral area, but rather the cross-sectional area can vary, in order to also act via the space delimiting surfaces on the friction conditions on the damping device.

In order to act on the first component when the components are braced relative to each other from two sides, it is proposed that the third component has two assemblies arranged on respectively one side of the first component. Thereby, the transverse forces occurring on bracing of the components are reduced or are at least limited to a smaller value. In addition, the construction allows various wedge surfaces and incline angles to be arranged on different sides of the first component and thereby allows a plurality of possibilities for influencing the friction values.

All the surfaces acting on each other of the first, second and third components can be equipped with friction surfaces. It is advantageous if the opposite components, formed as inclines, are formed without friction surfaces and the third component, lying opposite the second component, has at least one friction surface.

The friction surface can have a texture and can be, for example, grooved or slotted. Here, the structures can extend radially on the friction surface or can also run around in a circular shape. The friction surface can be provided here on the third component or on the second component. Depending on the case of application, a friction surface on both sides may also be advantageous.

In one example embodiment, provision is made that the third component facing the first component has at least one incline and the first component facing the third component has at least one incline. These inclines lead to a bracing of the components relative to each other and increase the friction between the third component and the second component.

These inclines can be shaped as desired, in order to bring about different friction values. Here, especially the dynamic behaviour of the friction device is to be taken into account. The inclines can therefore be formed as oblique planes or else as a curved surface, in order to achieve a continuous defined increase in friction on bracing, at the latest after a clearance angle.

The inclines can be fastened to a metal sheet or can be formed integrally with an encircling metal sheet. Here, the wedges are preferably made of plastic or metal. They can be cast, injected or sintered. A simple production of the inclines is achieved in that the inclines are stamped into a metal sheet, or drawn.

It is advantageous here if a clearance angle is provided. This is achieved for example in that the third component is movable with a play relative to the first component. This play makes possible, on a particular range of rotation of the first to second component relative to each other, a rotation with minimum friction stress, and the adjoining incline increases the friction coefficient on a further rotation in accordance with the gradient of the incline.

An advantageous construction of the damping device makes provision that the first component has a flange which is in operative connection with a spring system. Here, a first flange extends preferably from the friction surfaces of the damping device radially inwards and is connected there with a flange again leading radially outwards, which strikes against the springs.

The second component also preferably has a flange which is connected with a spring system. This flange can also be constructed as a double flange, between which the flange extends which is in operative connection with the first component.

Such an arrangement also makes it possible, in addition to a flange which is in operative connection with the springs, to arrange a flier which is likewise in operative connection with the spring system. However, the damping device does not have to have a flier. It can, for example, also be constructed as a damped friction disc, in which the primary and the secondary sides are directly connected with springs.

Whereas the first and the second components serve to transfer a force from the primary side via the spring system onto a secondary side, the flier serves to hold the springs of the spring system radially inwards, so that they are not drawn too far radially outwards by the acting centrifugal forces.

One variant embodiment makes provision that the first component has a flange in operative connection with the springs, and has a plate-shaped part. This plate-shaped part can serve to increase the primary mass and is constructed according to the required mass so that the respectively required primary mass is reached. It is advantageous if this plate-shaped part has a starter ring gear.

In order to ensure a simple construction of the damping device, it is proposed that a flange in operative connection with the springs, and the plate-shaped part are detachably connected with each other. This detachable connection is preferably achieved by means of toothing, such as spline toothing for example.

Particularly when the damping device is provided with a lubricant, it is proposed that a sealing element is arranged between a flange in operative connection with the springs, and the plate-shaped part. This sealing element can extend in a disc shape around the central part of the damping device and can prevent a penetration of lubricants from the side of the springs onto the opposite side of the sealing element.

It is proposed in particular for this that the sealing element has a sealing plate and at least one sealing lip. The sealing lip can cooperate for example with an axially extending flange.

The described construction of the damping device allows the friction device to be arranged radially at the height of a spring system or outside a spring system. This makes it possible to use lubricant which is present in the region of the springs also for the friction device. When sufficient axial structural space is available, an arrangement inside the spring system is also possible.

An axial arrangement adjacent to the springs is also possible, and it is therefore proposed that the friction device is arranged axially on the side of a spring system lying opposite the component which is able to be connected to the drive.

In the figures, two example embodiments of a damping device are described, which are explained in further detail below. It is to be noted here that the primary side and the secondary side can be exchanged with each other, without departing form the idea of the invention. This means that the primary side can be arranged externally, embracing everything, and the secondary side can be arranged further inside, or the secondary side forms the externally encircling ring whilst the primary side is arranged inside.

In the drawings

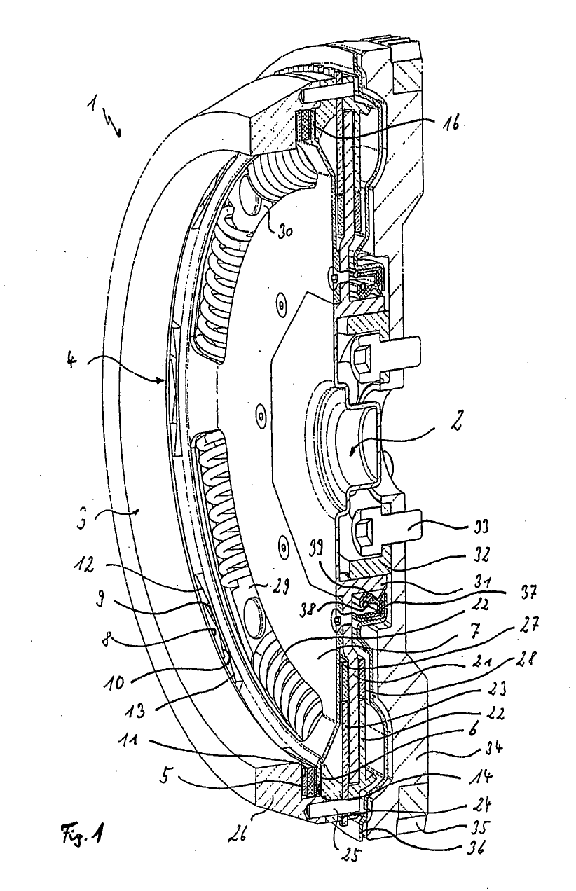

FIG. 1 shows a view, partially in section, of a damping device which has a friction device with a wedge system arranged on one side on the primary side,

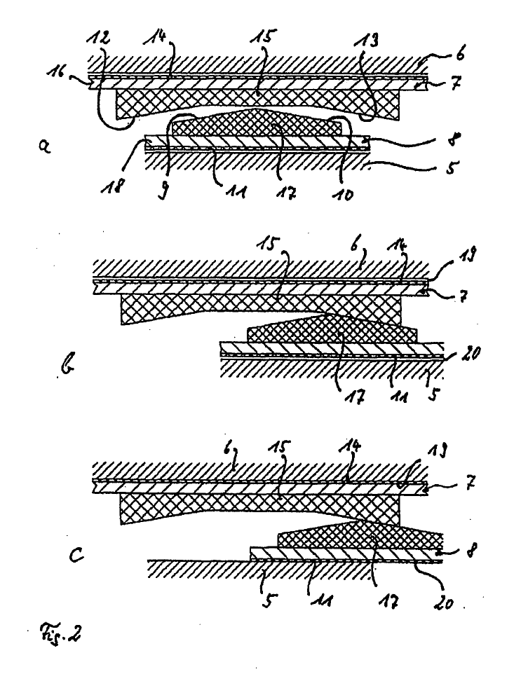

FIG. 2 shows the cooperation of friction surfaces of the friction device shown in FIG. 1 as a development in various positions,

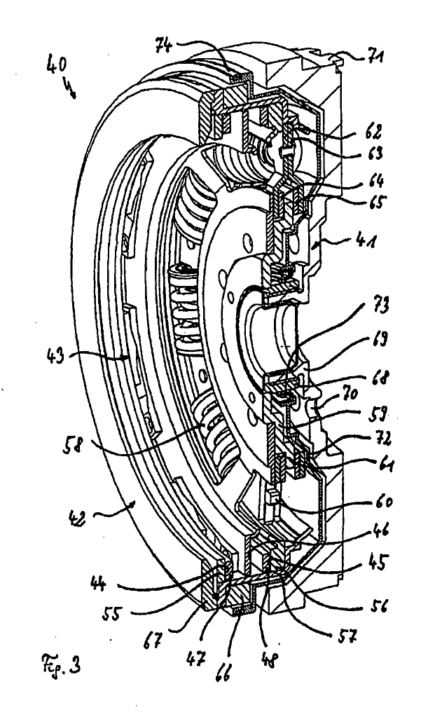

FIG. 3 shows a view, partially in section, of a damping device which has a friction device with wedge systems arranged on both sides from the primary side,

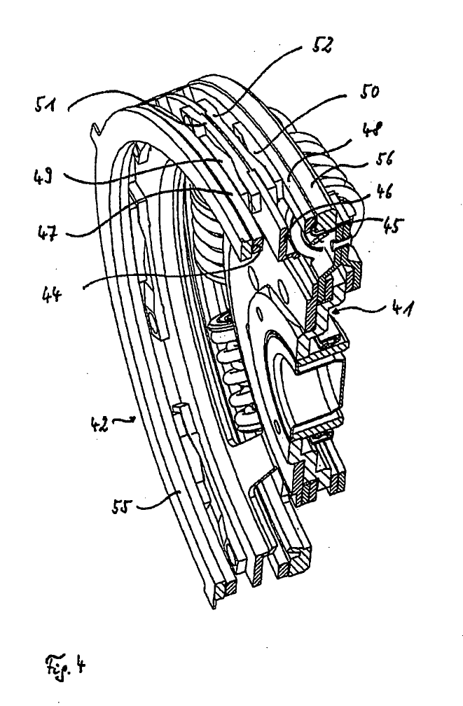

FIG. 4 shows a top view onto the cut out friction device from FIG. 3 and

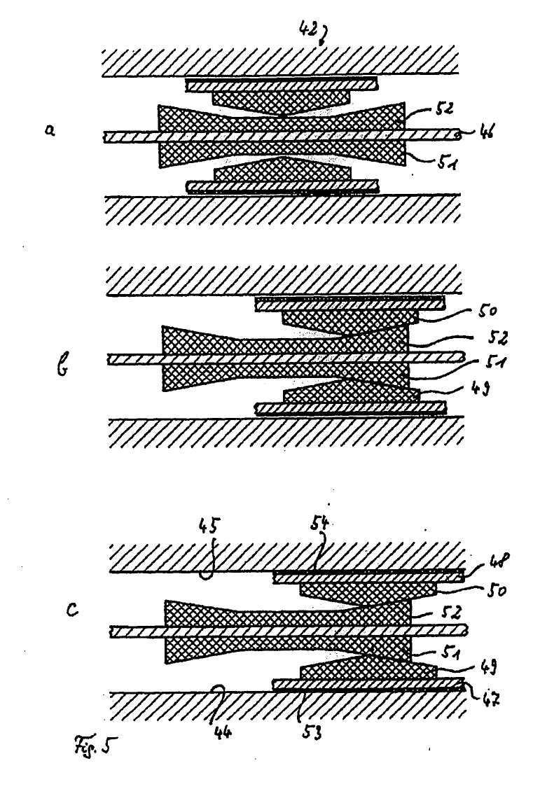

FIG. 5 shows the cooperation of friction surfaces of the friction device shown in FIG. 3 as a development in various positions.

The damping device 1 shown in FIG. 1 consists substantially of the first component 2 which is able to be connected as primary side with the crankshaft of a motor, and the second component 3, which is able to be connected as secondary side with a coupling and a gear. A friction device 4 is provided between the first component 2 and the second component 3.

The second component 3 has two distanced surfaces 5 and 6, and a flange 7 of the first component 2 projects into the space between these distanced surfaces 5 and 6. In the space between the distanced surfaces 5 and 6 of the second component 3, a third component 8 is arranged which has a oblique surfaces 9 and 10 on its side lying opposite the first component, and has a friction surface 11 on its side lying opposite the second component.

The oblique surfaces 9 and 10 are arranged between two inclines 12 and 13 fastened to the flange 7 of the first component 2, so that with a relative movement between the components 2 and 3, the oblique surface 9 cooperates with the incline 12 or the oblique surface 10 cooperates with the incline 13. The oblique surfaces 9 and 10 are arranged at a distance from the corresponding inclines 12 and 13 such that the oblique surfaces 9, 10 only come to lie against the inclines 12, 13 after a movement within the scope of a clearance angle. In the case of a rotation beyond the extent of the clearance angle, the oblique surfaces cooperate with the inclines such that the friction facing 11 of the third component 8 rubs on the side 5 of the second part 3, in which according to the angle of the inclines 12, 13 and the oblique surfaces 9, 10, the friction on the friction surface 11 increases or decreases according to the degree of rotation of the first and third components in relation to each other.

By the bracing of the first and third components relative to each other, however, not only is the third component 8 pressed via the friction surface 11 onto the side 5 of the second component 3, but the radially external end of the flange 7 of the first component 2 is also pressed against the side 6 of the second component 3. In order to increase the friction in this region, a friction surface 14 is also provided on the radially external end of the flange 7, which friction surface 14 cooperates with the side 6 of the second component 3.

The cooperating of the first, second and third components is illustrated once again in FIG. 2. FIG. 2a shows a basic position, in which the flange 7 of the first component 2 and the third component 8 lie freely movably between the two sides 5 and 6 of the second component 3. Both the friction surface 14 provided on the flange 7 of the first component 2 and also the friction surface 11 provided on the third component 8 lie slightly distanced from the surfaces 5 and 6 of the second component 3 and also the oblique surfaces 9 and 10 on the third component 8 lie distanced from the inclines 12 and 13 of the flange 7 of the first component 2.

In the example embodiment of FIG. 1, a primary wedge 15 with the inclines 12 and 13 is fastened on the radially outer end 16 of the flange 7 of the primary part 2. On the third component 8, a tertiary wedge 17 is fastened on a ring-shaped disc 18.

However, the wedges 15 and 17 can also be worked directly into the end 16 of the flange 7 or into the ring-shaped disc 18 of the third part 8 for example by a deformation.

A comparison of FIGS. 2a and 2b shows that the tertiary wedge 17 can move within a clearance angle relative to the primary wedge 15, without the gap 19 between the friction surface 14 on the flange 7 of the first part 2 and the side 6 of the second part 3 being reduced. In addition, with a movement within the clearance angle, the gap 20 between the friction surface 11 and the side 5 of the second part 3 is also not reduced. This takes place for example when idling or in operation with a constant load. Here, only the spring system is stressed and almost no friction is produced on the friction device. This clearance angle generally lies between ±3 and ±7 degrees and is approximately ±6 degrees in a diesel motor for example.

A comparison of FIGS. 2b and 2c shows that after an abutment of the tertiary wedge 17 on the primary wedge 15, with a further relative movement of the flange 7 of the first part 2 to the third component 8, the friction surfaces 11 and 14 are pressed against the sides 5 and 6 of the second part 3. The wedges 15 and 17 slide on each other and the gaps 19 and 20 become zero. The wedge 15 on the primary side entrains the tertiary wedge 17 and owing to the axial force which occurs, gives itself a torque counteracting the relative rotation of the wedges to each other. This is then damper or the friction device 4.

The first component 2, which is connected with the second component 3 on the secondary side via the flange 7 and the friction device 4, has a further flange 21 which cooperates with springs 22 as spring abutment on the primary side. The two flanges 22 and 23 extending from radially outwards inwards act as spring abutment on the secondary side. The flange 22 is connected via the flange 23 with a ring-shaped component 24, which also forms the abutment 6, and the flange 23 is fastened to this component 24 by means of a pin 25. The pin 25 additionally connects the flanges 22 and 23 with a further ring-shaped component 26, which forms the abutment 5 and which is able to be connected with a coupling or a gear.

Radially inside the flanges 22 and 23, on both sides of the flange 21 in each case a flier 27 or 28 is arranged, which is constructed as a ring-shaped component and has radially extending ends 29, 30 which hold the springs 22 and counteract a centrifugal force acting on the springs.

The flange 21 of the first component 2 has an axial extension 31 which cooperates via spline toothing with an angle plate 32. The angle plate 32 is connected by means of a screw 33 with a plate-shaped sheet metal or cast part 34. This plate-shaped part 34 is therefore counted as the primary mass and can be formed from different material and in different dimensions, according to the requirements of the required mass. In the present example embodiment, in addition a starter ring gear 35 is provided on the radially outer end of the plate-shaped part 34.

Between the plate-shaped part 34 and the flange 22, which is likewise on the primary side, a disc-shaped sealing plate 36 is arranged, which extends approximately from the axially extending flange 31 up to the radially outermost end of the damping device 1. At the radially inner end of the sealing plate 36, a sealing lip 39 is arranged, which is provided with an L-shaped reinforcement 37 and a clamping ring 38, and which lies against the axially extending flange 31. An L-shaped seal—for example as a PTFE sealing lip—is also conceivable, which can also be injected directly onto the sealing plate 36.

The sealing plate 36 can be connected or become connected at its radially outer end with a housing (not shown) . A region which is acted upon by lubricant is thereby produced in the drawing on the left hand side of the sealing plate 36, in which the springs and the friction device are arranged. This space is sealed by the sealing plate 36, so that no lubricant can reach the plate-shaped part 34.

The damping device 40 shown in FIG. 3 has a first component 41 on the primary side, i.e. able to be connected with the crankshaft of a motor, a second component 42 on the secondary side, able to be connected with a coupling or a gear, and a friction device 43 arranged therebetween.

In contrast to the example embodiment shown in FIG. 1, the friction device 43 is constructed with double flow. For this, the friction device consists of parts constructed in mirror image, which cooperate from two opposite sides with the first component 41. For this, the second component 42 has two distanced surfaces 44 and 45, between which one end 46 of the first component 41 is arranged.

In addition, between these surfaces 44 and 45 two third components 47 and 48 are arranged which are constructed in mirror image and on which respectively a tertiary wedge 49 or 50 is fastened. The tertiary wedges 49, 50 cooperate with primary wedges 51 and 52 fastened on the end 46 of the primary component 41, so that with a relative movement between the primary component 41 and the parts 47 and 48 of the third component, the first component 41 and the third component 47, 48 are braced such that the lateral surfaces of the components 47 and 48 are pressed against the surfaces 44 and 45 of the secondary component 42.

This process is explained once again in further detail in FIG. 5. FIG. 5a shows how the end 46 of the primary component 41 with the primary wedges 51 and 52 is freely movable within the scope of a movement over a specific clearance angle relative to the secondary second component 42, until the primary inclines 51 and 52 lie against the tertiary inclines 49 and 50. With a further movement of the wedges relative to each other, the wedges 49 and 50 are pressed against the abutment surfaces 44 and 45. In so doing, friction surfaces 53 and 54, arranged on the parts 47 and 48, place themselves against the sides 44 and 45, whereby a friction occurs between the first component 41 on the primary side and the second component 42 on the secondary side.

The two surfaces 44 and 45, which serve as abutment for the friction surfaces 53 and 54, are provided on ring-shaped components 55 and 56. These ring-shaped components 55 and 56 are, in turn, arranged on a ring-shaped support component 57 extending substantially in the axial direction. The support component 57, together with the ring-shaped component 56, forms the abutment surface on the secondary side for the springs 58, and a cup-like component 59 which is connected with the flange-like component 46, has radial extensions 60 which serve as an abutment surface on the primary side for the springs 58.

The cup-like component 59 has a shorter radial extension 61 between the radial extensions 60, and on both sides of this radial extension 61, flier plates 62 and 63 or 64 and 65, which are riveted to each other at their radially outer ends, are arranged so as to be freely movable. The flier plates which are connected with each other can also be screwed, welded or connected by tox clinching. These flier plates hold the springs 58 by radial extensions and counteract a centrifugal force acting on the springs 58.

An encircling ring 66 holds the plate 57 and acts as an additional mass, just as the encircling ring 67, which is likewise fastened to the support plate 57 and can also serve as a clamping ring for connection to the coupling.

The cup-like component 59 is connected radially inwardly with a ring-shaped component 68 which has a toothing by means of which it is connected with a plate-shaped component 69. This plate-shaped component 69 has bores 70 via which the entire first component 41 is able to be fastened to a crankshaft (not shown). Furthermore, the plate-shaped component 70 has a radial extension which is constructed as an additional mass and has a trigger toothing 71 for measuring the rotation rate, and has a shoulder to receive a toothed ring (not shown).

Between the plate-shaped component 69 and the springs 58 and the friction device 43, a sealing plate 72 is arranged, which has a sealing lip 73 on its radially inner side. This sealing lip 73 seals against the axially extending component 68 on the primary side, and it has on its radially outer end a ring-shaped seal 74 which cooperates with a housing wall (not shown). The sealing plate 72 therefore delimits a region of the springs 58 and friction device 43 which is acted upon by lubricant, and prevents the lubricant from emerging towards the plate-shaped component 69.

1. A damping device, particularly for a dual mass flywheel, comprising a first component and a second component and a friction device arranged therebetween, wherein the second component has two distanced surfaces and the first component is arranged between said surfaces and a third component is likewise arranged between said surfaces, in which when the third component and first component move towards each other, they are braced in such a way that surfaces of the first and third component are pressed against surfaces of the second component.

2. The damping device according to claim 1, wherein the first component is able to be connected with a drive and the second component with an output.

3. The damping device according to claim 1, wherein the first component is able to be connected with an output and the second component with a drive.

4. The damping device according to claim 1, wherein a ring-shaped space is formed between the distanced surfaces.

5. The damping device according to claim 4, wherein the ring-shaped space is closed radially outwards.

6. The damping device according to claim 4, wherein the ring-shaped space has a lubricant.

7. The damping device according to claim 4, wherein the ring-shaped space has openings for the inflow and the outflow of lubricant.

8. The damping device according to claim 1, wherein the first and the third component are arranged between the surfaces of the second component so as to be movable relative to each other and movable to the second component.

9. The damping device according to claim 1, wherein the third component has two assemblies arranged on respectively one side of the first component.

10. The damping device according to claim 1, wherein the third component lying opposite the second component has at least one friction surface.

11. The damping device according to claim 10, wherein the friction surface is grooved or slotted.

12. The damping device according to claim 1, wherein the third component facing the first component has at least one incline.

13. The damping device according to claim 1, wherein the first component facing the third component has at least one incline.

14. The damping device according to claim 12, wherein at least one incline has a curved surface.

15. The damping device according to any of claims 12, wherein the incline is stamped into an encircling sheet, or drawn.

16. The damping device according to claim 1, wherein the third component is movable with a play relative to the first component.

17. The damping device according to claim 1, wherein the first component has a flange which is in operative connection with a spring system.

18. The damping device according to claim 1, wherein the second component has a flange which is in operative connection with a spring system.

19. The damping device according to claim 17, wherein in addition to a flange in operative connection with the spring system, a flier is arranged which is likewise in operative connection with the spring system.

20. The damping device according to claim 1, wherein the first component has a flange in operative connection with the springs, and a plate-shaped part.

21. The damping device according to claim 20, wherein the plate-shaped part has a starter ring gear.

22. The damping device according to claim 20, wherein a flange in operative connection with the springs, and the plate-shaped part are preferably connected with each other detachably via a toothing.

23. The damping device according to claim 20, wherein a sealing element is arranged between a flange in operative connection with the springs, and a plate-shaped part.

24. The damping device according to claim 23, wherein the sealing element has a sealing plate and at least one sealing lip.

25. The damping device according to claim 24, wherein the sealing lip cooperates with an axially extending flange.

26. The damping device according to claim 1, wherein the friction device is arranged radially at the height of a spring system or outside a spring system.

27. The damping device according to claim 1, wherein the friction device is arranged axially on the side of a spring system lying opposite the component which is able to be connected with the drive.
